(19) United States
(12) Patent Application Publication
(10) Pub. No.: US 2003/0219612 A1
(43) Pub. Date: Nov. 27, 2003

(54) Polymeric films

(76) Inventor: Robert James Massey, Bristol (GB)

Correspondence Address: BLANK ROME LLP, THE FARRAGUT BUILDING, SUITE 1000, 900 17TH STREET, NW, WASHINGTON, DC, 20006, US

(21) Appl. No.: 10/443,802

(22) Filed: May 23, 2003

(30) Foreign Application Priority Data
May 23, 2002 (GB) GB0211772.9

(51) Int. Cl. B32B 27/00

(52) U.S. Cl. 428/515; 428/500

(57) ABSTRACT

Coextruded polymeric films comprising at least one base layer and an outer cold seal layer formed from a blend of a synthetic rubber and a tackifier, at least one of the outer surfaces of the film including an antiblock agent. Such films can be cold sealed cold seal layer to cold seal layer without substantial adhesion to the other outer surface of the films.

### FIELD OF THE INVENTION

This invention concerns polymeric films having cold seal properties, that is the ability of a surface of the film to seal to itself at room temperature by pressure alone, but not to seal to other surfaces under such conditions.

### BACKGROUND OF THE INVENTION

Cold sealability, is usually imparted to polymeric films by applying a coating of an adhesive composition consisting of a rubber dispersed in water or dissolved in a solvent, the composition usually being applied by printing the dispersion or solution on to the surface of the film. However, the use of such compositions in limited by the necessity to apply them as a coating to pre-formed polymeric films.

In theory it should be possible to coextrude cold seal layers with other layers of polymeric films. However, materials used hitherto as printable cold seal layers present problems if coextruded with other layers of a film due to their often having very high melt viscosities which can make coextrusion difficult if not impossible, a lack in many cases of thermal stability at the temperatures used to effect coextrusion, and undesirable adhesion of the film to itself when the film is wound up. This occurs despite cold seal materials supposedly only adhering to themselves.

### SUMMARY OF THE INVENTION

According to the present invention there is provided a coextruded polymeric film comprising at least one base layer and an outer cold seal layer formed from a blend of a synthetic rubber and a tackifier, at least one of the outer surfaces of the film including an antiblock agent.

### DESCRIPTION OF PREFERRED EMBODIMENTS

The antiblock agent can be present in either or both of the outer surfaces of the film, but it is preferably in the layer formed from the blend forming the cold seal layer.

The antiblock agent is preferably in the form of particles having a mean particle size of at least 1 μm, and more preferably in the range of from 2 to 20 μm.

The antiblock agent can be organic, for example cross-linked acrylic particles, or inorganic, for example talc or glass microbeads.

The amount of antiblock agent when present in the layer formed from a blend of a synthetic rubber and a tackifier is preferably from 5 to 30 percent by weight of the cold seal layer.

Synthetic rubbers used in the cold seal layer of films of the present invention are preferably non-polar. Particularly preferred rubbers for use in accordance with the present invention include tri-block copolymers with two terminal blocks derived from styrene, and more particularly such tri-block polymers containing central blocks derived from one or more aliphatic olefins, for example ethylene, butylene, butadiene and isoprene. Examples of block copolymers for use in accordance with the present invention include styrene/isoprene/styrene copolymers, styrene/(ethylene/co-butylene)/styrene copolymers, and styrene/butadiene/styrene copolymers. The tri-block polymers used in accordance with the present invention will often contain di-block copolymers, that is copolymers consisting of a single block derived from styrene and a single block derived from one or more aliphatic olefins, and this is generally acceptable provided the amount of di-block polymer present does not adversely affect the cold seal properties of the blend containing these materials.

The tackifier is preferably non-polar when the rubber is non-polar. Preferred tackifiers are aliphatic compounds and amorphous tackifiers are also preferred. The mean molecular weight of the tackifier is preferably from 800 to 15000. The glass transition temperature (T_{g}) of the tackifier is preferably from 80 to 135° C., and more preferably about 125° C. A particularly preferred tackifier is sold by Hercules Inc under the Trade Name Regalite R1125.

If a relatively polar rubber is used in compositions in accordance with the present invention it is generally preferred that the tackifier is also relatively polar.

Coextruded cold seal layers of films in accordance with the present invention preferably contain from 40 to 90, more preferably from 50 to 80, percent by weight of synthetic rubber, and from 3 to 30, more preferably from 5 to 20, percent by weight of a tackifier.

Films in accordance with the present invention can be produced by coextruding a blend of a synthetic rubber and a tackifier as an outer layer whilst simultaneously coextruding other layers of the films.

It should be noted that if the tackifier and the synthetic rubber are compounded and granulated to produce a granular feed for the coextrusion process, the granules are generally not free flowing as they tend to adhere to themselves, and this will result in problems in carrying out the coextrusion process.

As an alternative, the synthetic rubber and the tackifier can be granulated separately and then fed to an extruder for producing the cold seal layer, the extruder being relied upon to compound the ingredients within the extruder. However, suitable tackifiers are often extremely brittle, giving rise to difficulties in processing them using conventional polymer processing equipment, for example when blending them with antiblock agents. Furthermore, blending an antiblock agent into a tackifier generally does little to improve the very low melt viscosity of the tackifier, the latter causing problems when attempts are made to blend the tackifier with a rubber using a single screw extruder. Problems therefore arise because of the dramatically different rheological properties of synthetic rubbers and tackifiers.

Films in accordance with the present invention can, however, be satisfactorily produced by feeding a blend of particles of the synthetic rubber and particles of a blend of the tackifier and a polyolefin through a single screw extruder. The particles, which in both cases are preferably in the form of pellets, can be produced separately prior to their being coextruded, using conventional polymer coompounding equipment.

The blend of a tackifier and a polyolefin preferably contains from 20 to 70 percent by weight of a tackifier and from 10 to 40 percent by weight of a polyolefin, based on the weight of the blend. The antiblock agent is preferably present in an amount of up to 50 percent by weight based on the weight of the blend.

The antiblock agent can be present in synthetic rubber particles and/or in the tackifier particles. When present in the synthetic rubber particles rather than in the tackifier particles, the antiblock agent can be present in an amount of up to 50% by weight of the synthetic rubber particles.

The polyolefin is preferably polyethylene, for example having a density of less than 0.930 g/cm³. The melt flow index (MFI) of the polyethylene is preferably less than 10 g/min (ISO 1133, at 190° C. and 2.16 kg). However, other types of polyethylene can be used.

Blends of a tackifier and a polyolefin, optionally containing an antiblock agent, used for producing films in accordance with the present invention can be prepared by melt blending the desired amounts of the various components of the blend and forming them into pellets or granules. Such blends can then themselves be simply physically mixed with particles of the synthetic rubber, optionally containing an antiblock agent, preferably in the form of granules. The resulting mixtures, which in general are free flowing, can be handled by conventional polymer processing and transport methods, this apparently being due to the similarity in the rheological properties of the components of the mixtures. For example they can be fed into a single screw extruder without handling problems, particularly without becoming tacky, and then extruded to form cold seal layers on films produced by coextruding the required further layer or layers of the films.

Films in accordance with the present invention will in general have a single outer layer with either or both outer surfaces containing particles of an antiblock agent which in general, should be present in an amount sufficient to reduce blocking between opposite surfaces of the films. Such films can in general be wound up in conventional manner after production and thereafter unwound, since the cold sealable layer does not contact itself during these operations. However, when the cold sealable layer is contacted with itself, it adheres strongly. For example, peel strengths of 5.0N/15 mm have been achieved by applying a pressure of 200 KPa for 1 second to such films with their cold sealable layers in contact.

The thickness of cold seal layers of films in accordance with the present invention can vary widely, for example depending on the materials used to form the compositions and/or the nature of the film or films on which it is present and/or the intended end use. Thus these layers can be from 0.5 to 50 μm thick.

The cold seal layer of films in accordance with the present invention can be formed as coextruded layers directly on other layers of the films. However, a tie layer can be used to improve adhesion of the cold seal layer to other layers of the films. For example, a layer of an ethylene/vinyl acetate copolymer can be used as a tie layer between the cold seal layer and a layer of high density polyethylene.

The following Example is given by way of illustration only.

### EXAMPLE

A blend of 34 percent by weight of tackifier (Regalite R1125-Hercules, Inc), 16 percent by weight of low density polyethylene, 20 percent by weight of linear low density polyethylene, and 30 percent by weight of talc were fed to a twin screw extruder and formed into pellets.

41 percent by weight of a styrene/isoprene/styrene block copolymer granules (18 percent by weight of units derived from styrene in the two blocks and leas than 1 percent by weight of styrene/isoprene di-block copolymer) were then simply mixed with tackifier/polyethylene granules to form a free flowing mixture of granules.

A three layered polymeric film was then produced by coextruding melts of this blend with melts of two other polymers through a slot die, this blend forming one outer layer of the film, and the other two layers being a second outer layer formed from high density polyethylene and a tie layer of an ethylene vinyl acetate copolymer (9 percent by weight of units derived from vinyl acetate) between the other two layer. The resulting film was cooled and wound up.

The layer formed from a composition in accordance with the present invention was 18 μm thick, the tie layer was 10 μm thick, and the high density polyethylene layer was 40 μm thick.

This film could be easily unwound from the roll. However, it readily cold sealed to itself when the layer formed from the composition in accordance with the present invention was contacted with itself and a pressure of 200 KPa was applied for 1 second with the film being at 21° C. The resulting seal had a peel strength of 5.0N/15 mm.

1. A coextruded polymeric film comprising at least one base layer and an outer cold seal layer formed from a blend of a synthetic rubber and a tackifier, at least one of the outer surfaces of the film including an antiblock agent.

2. A film according to claim 1, wherein the cold seal layer contains the antiblock agent.

3. A film according to claim 1, wherein the antiblock agent has a mean particle size of at least 1 μm.

4. A film according to claim 3, wherein the antiblock agent has a mean particle size of from 2 to 20 μm.

5. A film according to claim 1, wherein the synthetic rubber comprises a tri-block copolymers with two terminal blocks derived from styrene.

6. A film according to claim 5, wherein the central block of the tri-block copolymer is derived from one or more aliphatic olefins.

7. A film according to claim 6, wherein the aliphatic olefins comprise ethylene, butylene, butadiene and isoprene.

8. A film according to claim 1, wherein the synthetic rubber comprises a styrene/isoprene/styrene copolymer, a styrene/(ethylene/co-butylene)/styrene copolymer, or a styrene/butadiene/styrene copolymer.

9. A film according to claim 1, wherein the synthetic rubber and the tackifier are both non-polar.

10. A film according to claim 1, wherein the tackifier comprises an aliphatic compound.

11. A film according to claim 1, wherein the tackifier is substantially amorphous.

12. A film according to claim 1, wherein the tackifier has a mean molecular weight of from 800 to 15000.

13. A film according to claim 1, wherein the tackifier has a glass transition temperature (T_{g}) of from 80 to 135° C.

14. A film according to claim 1, wherein the cold seal layer contains a polyolefin.

15. A film according to claim 14, wherein the said polyolefin comprises a polyethylene.

16. A film according to claim 15, wherein the polyethylene has a density of less than 0.930 g/cm³.

17. A method of producing a film according to claim 1, wherein the components of the cold seal layer are coextruded with melts of polymers required for the base and other required layers.

18. A method according to claim 17, wherein the rubber and the tackifier for the cold seal layer are fed by a single screw extruder, the rubber and the tackifier being in the form of separate pellets, the tackifier pellets themselves having been produced by blending the tackifier with a polyolefin.
